(19) United States
(12) Patent Application Publication
(10) Pub. No.: US 2018/0162027 A1
(43) Pub. Date: Jun. 14, 2018

(54) METHOD FOR MAKING GOLF BALL AND GOLF BALL MADE THEREBY

(71) Applicant: LAUNCH TECHNOLOGIES CO., LTD., Pingtung City (TW)

(72) Inventors: Shih-Jie LIN, Pingtung City (TW); Ti-Szu CHIU, Pingtung City (TW); Ping-Hsiu SHIH, Pingtung City (TW); Fun-Kun SU, Pingtung City (TW); Jong-Cheng TSAI, Pingtung City (TW)

(21) Appl. No.: 15/484,680

(22) Filed: Apr. 11, 2017

(30) Foreign Application Priority Data
Dec. 12, 2016 (TW) 105140993

(51) Int. Cl. B29C 45/14; B29C 70/70; B29C 70/68; B29C 45/16; A63B 37/00; A63B 43/00; A63B 45/00

(52) U.S. Cl. CPC B29C 45/14819; B29C 70/70; B29C 70/683; B29K 2021/00; A63B 37/0075; A63B 43/004; A63B 45/00; B29C 45/1671

(57) ABSTRACT

A method for making a golf ball includes: wrapping a sensing module with a polymeric band to produce a spherical core in which the sensing module is entirely enclosed by the polymeric band; molding a molding material to form an intermediate layer that surrounds the spherical core, wherein the polymeric band acts as a barrier to prevent the molding material from intruding into the sensing module through the polymeric band; and molding a shell to surround the intermediate layer. A golf ball is also provided, and includes a spherical core, an intermediate layer surrounding the spherical core, and a shell surrounding the intermediate layer. The spherical core includes a sensing module, and a polymeric band wrapped around and entirely enclosing the sensing module.

### CROSS-REFERENCE TO RELATED APPLICATION

This application claims priority of Taiwanese Patent Application No. 105140993, filed on Dec. 12, 2016.

### FIELD

The disclosure relates to a method for making a golf ball and a golf ball made thereby.

### BACKGROUND

With the advancement of sensing technology and miniaturization of sensing modules, the sensing modules are widely used in various fields for applications such as real-time positioning, data collection, etc. Conventional golf balls are implanted with the sensing modules to record data such as the speed and trajectory after the golf balls are hit by players, and the locations of the golf balls such that the players or others may easily find the golf balls on the golf course. Some golf balls are even implanted with a buzzer to indicate the locations of the golf balls with sound.

The conventional golf balls are also provided with batteries so as to provide electric power to the sensing modules or buzzers. However, high temperatures applied during the molding process of the golf balls may damage the sensing modules and the batteries.

### SUMMARY

Therefore, an object of the present disclosure is to provide a method for making a golf ball and a golf ball made thereby that can alleviate at least one of the drawbacks associated with the prior art.

According to a first aspect of the present disclosure, a method for making a golf ball includes:

(a) wrapping a sensing module with at least one polymeric band to produce a spherical core in which the sensing module is entirely enclosed by the at least one polymeric band;

(b) molding a molding material to form an intermediate layer that surrounds the spherical core, wherein the at least one polymeric band acts as a barrier to prevent the molding material from intruding into the sensing module through the polymeric band; and

(c) molding a shell to surround the intermediate layer.

According to a second aspect of the present disclosure, a golf ball includes a spherical core, an intermediate layer and a shell.

The spherical core includes a sensing module, and at least one polymeric band wrapped around and entirely enclosing the sensing module. The sensing module includes a chip and a battery electrically connected to the chip. The intermediate layer is molded over and surrounds the spherical core. The shell is molded over and surrounds the intermediate layer.

### BRIEF DESCRIPTION OF THE DRAWINGS

Other features and advantages of the present disclosure will become apparent in the following detailed description of the embodiment with reference to the accompanying drawings, of which:

FIG. 1 shows consecutive steps of an embodiment of a method for making a golf ball according to the present disclosure;

FIG. 2 shows a wrapping step of the embodiment of the method;

FIG. 3 shows a step of molding an intermediate layer of the embodiment of the method;

FIG. 4 shows a step of molding a shell of the embodiment of the method; and

FIG. 5 is a schematic sectional view of an embodiment of a golf ball according to the present disclosure.

### DETAILED DESCRIPTION

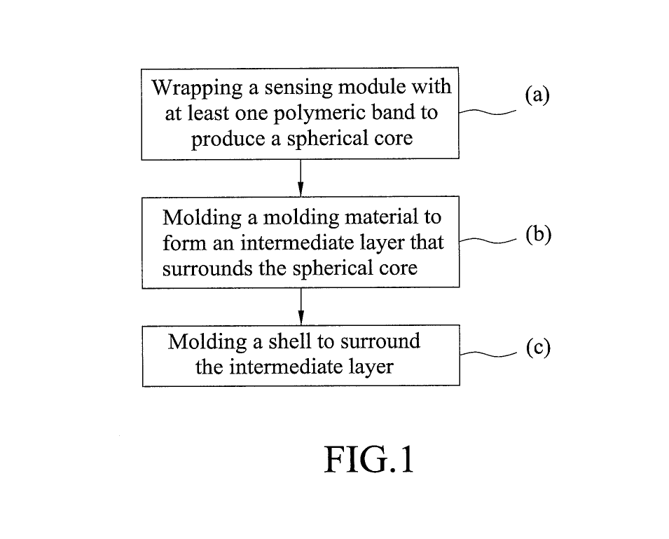

Referring to FIGS. 1 to 5, an embodiment of a method for making a golf ball 1 includes:

(a) wrapping a sensing module 31 with at least one polymeric band 33 to produce a spherical core 3 in which the sensing module 31 is entirely enclosed by the polymeric band 33;

(b) molding a molding material to form an intermediate layer 5 that surrounds the spherical core 3, in which the polymeric band 33 acts as a barrier to prevent the molding material from intruding into the sensing module 31 through the polymeric band 33; and

(c) molding a shell 7 to surround the intermediate layer 5.

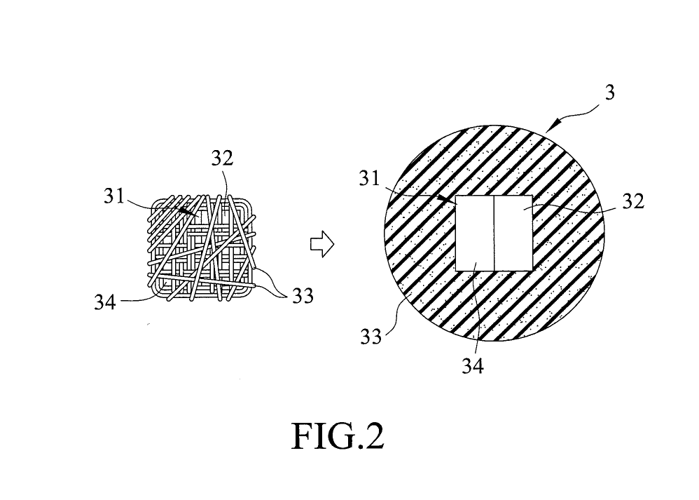

Referring to FIG. 2, in step (a), the sensing module 31 includes a chip 34 and a battery 32 electrically connected to the chip 34. In this embodiment, the polymeric band 33 is an elastic band, and is exemplified to be made of rubber. In certain embodiments, the at least one polymeric band 33 includes a plurality of the polymeric bands 33 that are wrapped around the sensing module 31, after which the polymeric bands 33 may be tied to forma knot. In certain embodiments, a center of gravity and a geometric center of the spherical core 3 are coincided with each other, and the sensing module 31 is substantially located at a center of the spherical core 3, thereby providing the golf ball 1 with better stability when being hit and traveling in air. In this embodiment, the spherical core 3 is exemplified to have a diameter not greater than 0.9 inch.

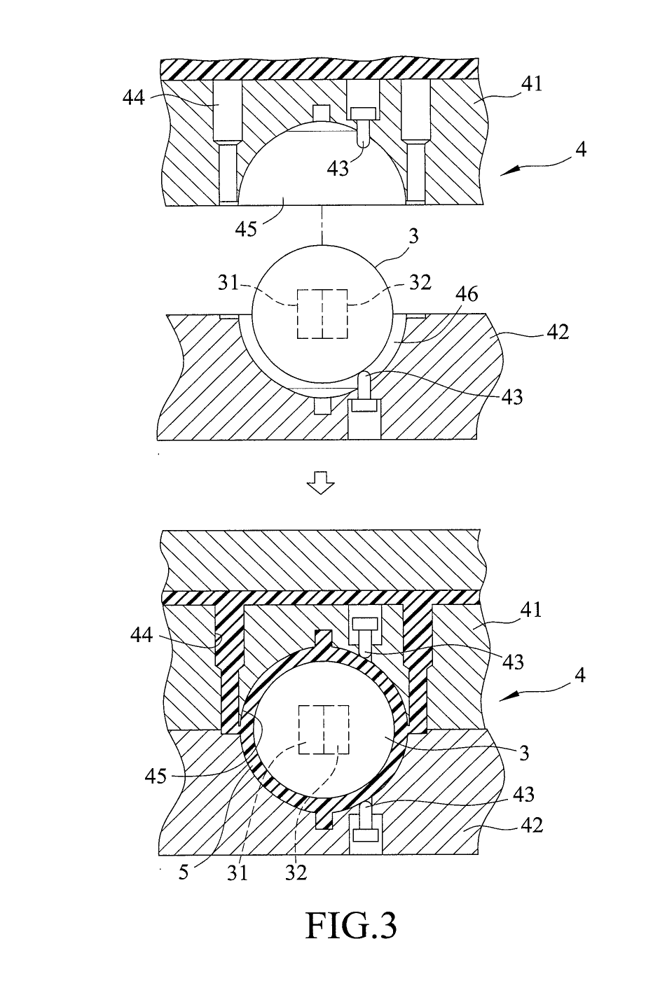

Referring to FIG. 3, in step (b), the spherical core 3 is placed into a first mold 4, which includes a first upper mold part 41, a f first lower mold part 42, a plurality of first pins 43 and a first guiding passage 44 formed in the first upper mold part 41. The first upper mold part 41 and the first lower mold part 42 cooperatively define a first mold cavity 45 for receiving the spherical core 3 and that is in spatial communication with the first guiding passage 44. The first pins 43 are movably mounted to the first upper mold part 41 and the first lower mold part 42 for fixing the spherical core 3 in the first mold cavity 45, and leaving a first space 46 between the spherical core 3 and the first upper and lower mold parts 41, 42. The first space 46 is spatially communicated with the first mold cavity 45, allowing the molding material to be filled in the first space 46 through the first guiding passage 44 and to be molded into the intermediate layer 5. In this embodiment, the molding material of the intermediate layer 5 has a melting temperature lower than that of the polymeric band 33 to avoid melting the polymeric band 33 and damaging the sensing module 31 during the molding process. The molding material of the intermediate layer 5 is exemplified to be selected from the group consisting of rubber, ionomer, and combinations thereof.

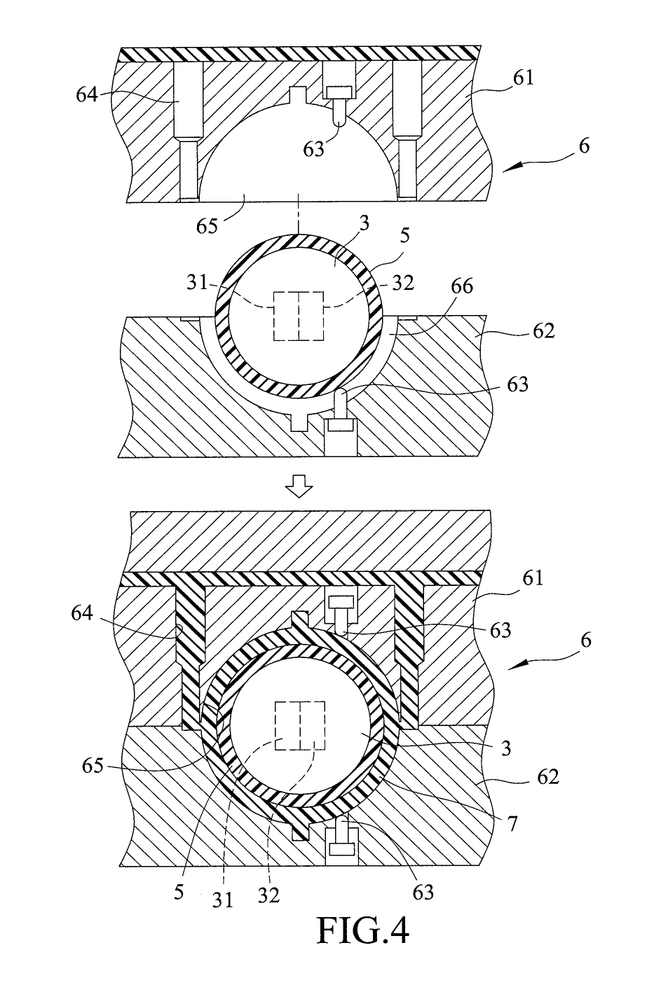

Referring to FIG. 4, in step (c), the intermediate layer 5 and the spherical core 3 enclosed therein are placed into a second mold 6, which includes a second upper mold part 61, a second lower mold part 62, a plurality of second pins 63 and a second guiding passage 64 formed in the second upper mold part 61. The first upper mold part 61 and the first lower mold part 62 cooperatively define a second mold cavity 65 that is for receiving the intermediate layer 5 and the spherical core 3, and that is in spatial communication with the second guiding passage 64. The second pins 63 are movably mounted to the second upper mold part 61 and the second lower mold part 62 for fixing the intermediate layer 5 and the spherical core 3 in the second mold cavity 65, and leaving a second space 66 between the intermediate layer 5 and the second upper and lower mold parts 61, 62. The second space 66 is spatially communicated with the second mold cavity 65, allowing a shell molding material to be filled in the second space 66 through the second guiding passage 64 and to be molded into the shell 7. The shell 7 is exemplified to be made of a material selected from the group consisting of ionomer, thermoplastic polyurethane, and combinations thereof.

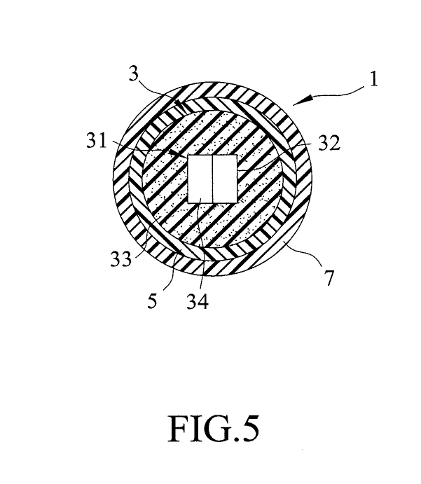

Specifically, referring to FIG. 5, an embodiment of the golf ball 1 of this disclosure, which may be produced by the above mentioned method, includes the spherical core 3, the intermediate layer 5 and the shell 7. The spherical core 3 includes the sensing module 31, and a plurality of the polymeric bands 33 wrapped around and entirely enclosing the sensing module 31. The sensing module 31 includes the chip 34 and the battery 32 electrically connected to the chip 34. The intermediate layer 5 is molded over and surrounds the spherical core 3. The shell 7 is molded over and surrounds the intermediate layer 5.

In the description above, for the purposes of explanation, numerous specific details have been set forth in order to provide a thorough understanding of the embodiment. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A method for making a golf ball, comprising:
a) wrapping a sensing module with at least one polymeric band to produce a spherical core in which the sensing module is entirely enclosed by the at least one polymeric band;
b) molding a molding material to form an intermediate layer that surrounds the spherical core, wherein the at least one polymeric band acts as a barrier to prevent the molding material from intruding into the sensing module through the polymeric band; and
c) molding a shell to surround the intermediate layer.

2. The method as claimed in claim 1, wherein the at least one polymeric band includes a plurality of said polymeric bands.

3. The method as claimed in claim 1, wherein the molding material of the intermediate layer has a melting temperature lower than that of the polymeric band.

4. The method as claimed in claim 1, wherein the polymeric band is an elastic band.

5. The method as claimed in claim 4, wherein the polymeric band is made of rubber.

6. The method as claimed in claim 1, wherein the spherical core has a diameter not greater than 0.9 inch.

7. The method as claimed in claim 1, wherein the molding material of the intermediate layer is selected from the group consisting of rubber, ionomer, and combinations thereof.

8. The method as claimed in claim 1, wherein the shell is made of a material selected from the group consisting of ionomer, thermoplastic polyurethane, and combinations thereof.

9. A golf ball, comprising:
a spherical core including a sensing module, and at least one polymeric band wrapped around and entirely enclosing said sensing module, said sensing module including a chip and a battery electrically connected to said chip;
an intermediate layer molded over and surrounding said spherical core; and
a shell molded over and surrounding said intermediate layer.

10. The golf ball as claimed in claim 9, wherein the at least one polymeric band includes a plurality of said polymeric bands.

11. The golf ball as claimed in claim 9, wherein said intermediate layer has a melting temperature lower than that of said polymeric band.

12. The method as claimed in claim 9, wherein the polymeric band is an elastic band.

13. The golf ball as claimed in claim 12, wherein said polymeric band is made of rubber.

14. The golf ball as claimed in claim 9, wherein said spherical core has a diameter not greater than 0.9 inch.

15. The golf ball as claimed in claim 9, wherein said intermediate layer is made of a material selected from the group consisting of rubber, ionomer, and combinations thereof.

16. The golf ball as claimed in claim 9, wherein said shell is made of a material selected from the group consisting of ionomer, thermoplastic polyurethane, and combinations thereof.
